(19) United States
(12) Patent Application Publication
(10) Pub. No.: US 2014/0300736 A1
(43) Pub. Date: Oct. 9, 2014

(54) MULTI-SENSOR CAMERA RECALIBRATION

(71) Applicant: Microsoft Corporation, (US)

(72) Inventors: Bernhard Reitinger, Krumegg (AT); Konrad Karner, Raaba (AT); Mario Hoefler, Gleisdorf (AT); Joachim Bauer, Graz (AT); Martin Ponticelli, Graz (AT); Michael Gruber, Graz (AT); Stephen Lawler, Kirkland, WA (US)

(73) Assignee: Microsoft Corporation, Redmond, WA (US)

(21) Appl. No.: 13/859,117

(22) Filed: Apr. 9, 2013

(51) Int. Cl. G06T 7/00

(52) U.S. Cl. CPC G06T 7/0018
USPC 348/144; 348/262

(57) ABSTRACT

One or more techniques and/or systems are providing for facilitating recalibration of a multi-sensor camera. That is, a multi-sensor camera may comprise a nadir sensor and one or more oblique sensors. Temperature, mechanical stress, and other factors can lead to misalignment of one or more sensors within the multi-sensor camera. Accordingly, a set of tie points and/or observations may be generated based upon a search matching technique, a densification technique, and/or a virtual matching technique. A bundle technique may be utilized to generate updated eccentricity information based upon the set of tie points and/or observations. The updated eccentricity information (e.g., orientation and/or position information of a sensor, such as an oblique sensor, with respect to a nadir view) may be used to recalibrate the multi-sensor camera, such as in real-time (e.g., during a flight mission that utilizes the multi-sensor camera to capture aerial images of a city or other scene).

### BACKGROUND

Various types of camera devices are used to capture imagery, such as aerial cameras, cell phone cameras, digital cameras, etc. In an example, a multi-sensor camera may comprise one or more sensors (e.g., camera heads) that are configured to capture images from various view directions. For example, the multi-sensor camera may comprise a nadir sensor configured to capture images of a scene from a substantially perpendicular view of the ground (e.g., a scene of a city from a top-down aerial view as observed by an aircraft flying over the city). The multi-sensor camera may comprise one or more oblique sensors (e.g., one or more wings sensors) configured to capture images of the scene from oblique angles (e.g., a tiled view relative to a nadir view) in order to enlarge a footprint (e.g., enlarge an effective viewing angle, enlarge ground coverage, etc. The multi-sensor camera may be initially configured (e.g., geometrically calibrated within a lab before a flight mission using the multi-sensor camera). During use, various external influences, such as temperature or mechanical stress, can result in misalignment between one or more sensors within the multi-sensor camera.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for facilitating recalibration of a multi-sensor camera are provided herein. In some embodiments, one or more sensors are correlated together on an image space to generate a set of tie points (e.g., a tie point corresponding to a physical 3D point and an associated 2D image measurement within an image captured by a sensor) and/or a set of observations (e.g., identification that a physical point on the ground is depicted by one or more images). Features may be extracted from images captured by respective sensors, and such features may be correlated together based upon image content to generate tie points and/or observations.

In an example of generating a set of tie points, a search matching component is configured to generate a set of tie points based upon performing a pair-wise image matching technique upon a set of image matching pairs (e.g., an image matching pair may identify a correspondence region between a first image and a second image, such as a corner of a house depicted by two images). In an example of generating an observation, a densification component may re-project 3D points (e.g., a 3D point derived from a nadir view) into an image (e.g., an image captured by an oblique sensor) to obtain corresponding coordinates that may be used to generate an observation using an image matching technique. In another example of generating a set of tie points, a virtual matching component may construct and/or texture a digital surface model that may be used to generate a set of synthetic rendered images. The set of synthetic rendered images may be evaluated using an image matching technique to generate a set of tie points. It may be appreciated that other techniques and/or combinations thereof may be utilized to identify tie points and/or observations.

A bundle adjustment component may be configured to iteratively evaluate a set of tie points or observations using initial calibration information of the multi-sensor camera to compute an estimated statistical error distribution (e.g., errors, such as differences between a measured coordinate in an image and image coordinates of a projected 3D point, within the set of tie points or observations that may occur due to differences in intrinsic camera parameters of sensors, such as focal length or resolution, and/or other factors). A set of weights may be generated based upon the estimated statistical error distribution. The set of weights may be applied to the set of tie points or observations using a non-linear optimization method (e.g. procedure), for example, to generate updated eccentricity information (e.g., relative orientation and/or positional information of an oblique sensor in relation to a nadir view, which may be based upon six degrees of freedom deviation of the oblique sensor from a reference nadir sensor). The updated eccentricity information may be used to recalibrate one or more sensors of the multi-sensor camera.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1A is a flow diagram illustrating an exemplary method of facilitating recalibration of a multi-sensor camera using a search matching technique.

FIG. 1B is a flow diagram illustrating an exemplary method of facilitating recalibration of a multi-sensor camera using a densification technique.

FIG. 1C is a flow diagram illustrating an exemplary method of facilitating recalibration of a multi-sensor camera using a virtual matching technique.

FIG. 2 is a component block diagram illustrating an exemplary system of facilitating recalibration of a multi-sensor camera using a bundle adjustment technique.

FIG. 3 is a component block diagram illustrating an exemplary system for facilitating recalibration of a multi-sensor camera using a search matching technique and/or a densification technique.

FIG. 4 is a component block diagram illustrating an exemplary system for facilitating recalibration of a multi-sensor camera using a densification technique.

FIG. 5 is a component block diagram illustrating an exemplary system for facilitating recalibration of a multi-sensor camera using a virtual matching technique.

FIG. 6 is an illustration of an exemplary computing device-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

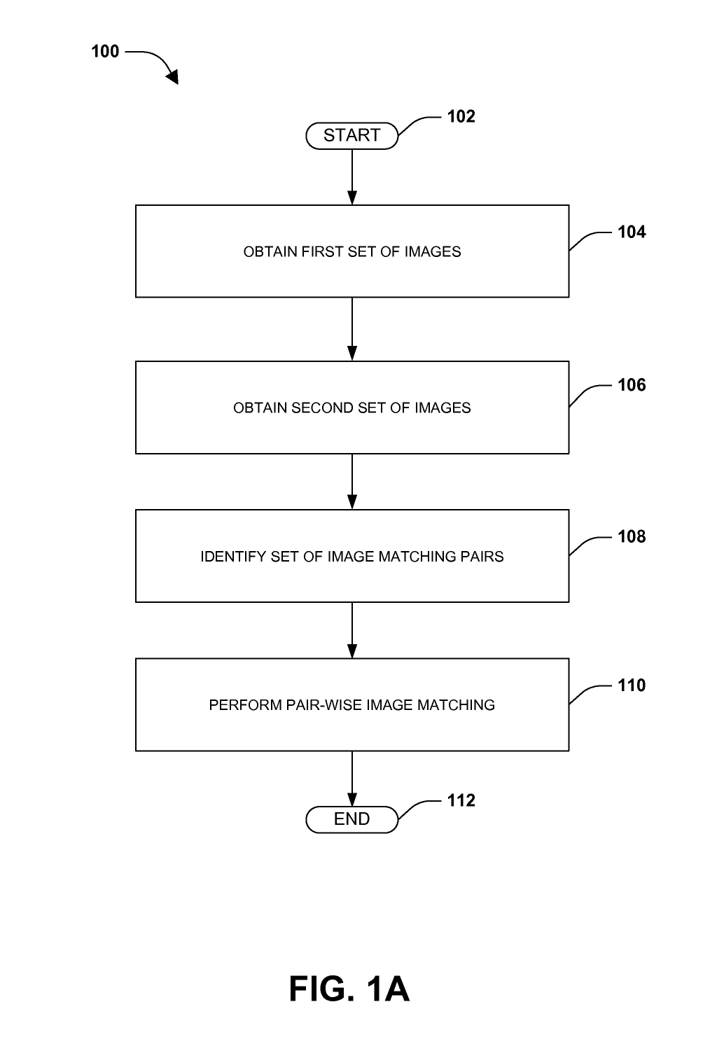

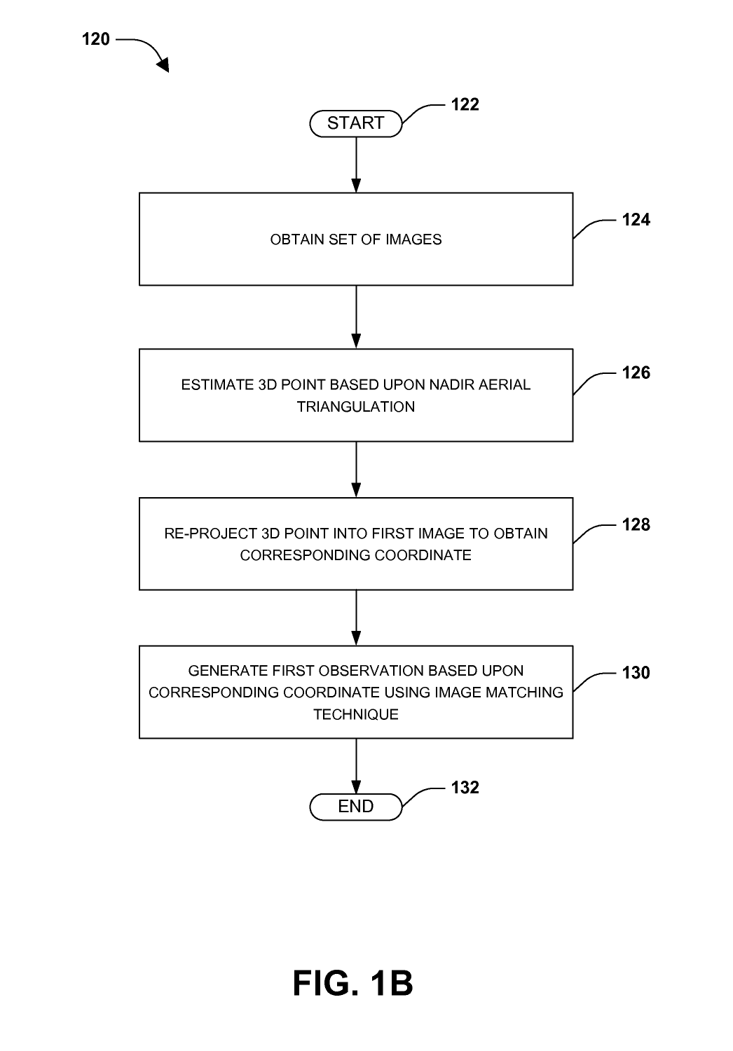

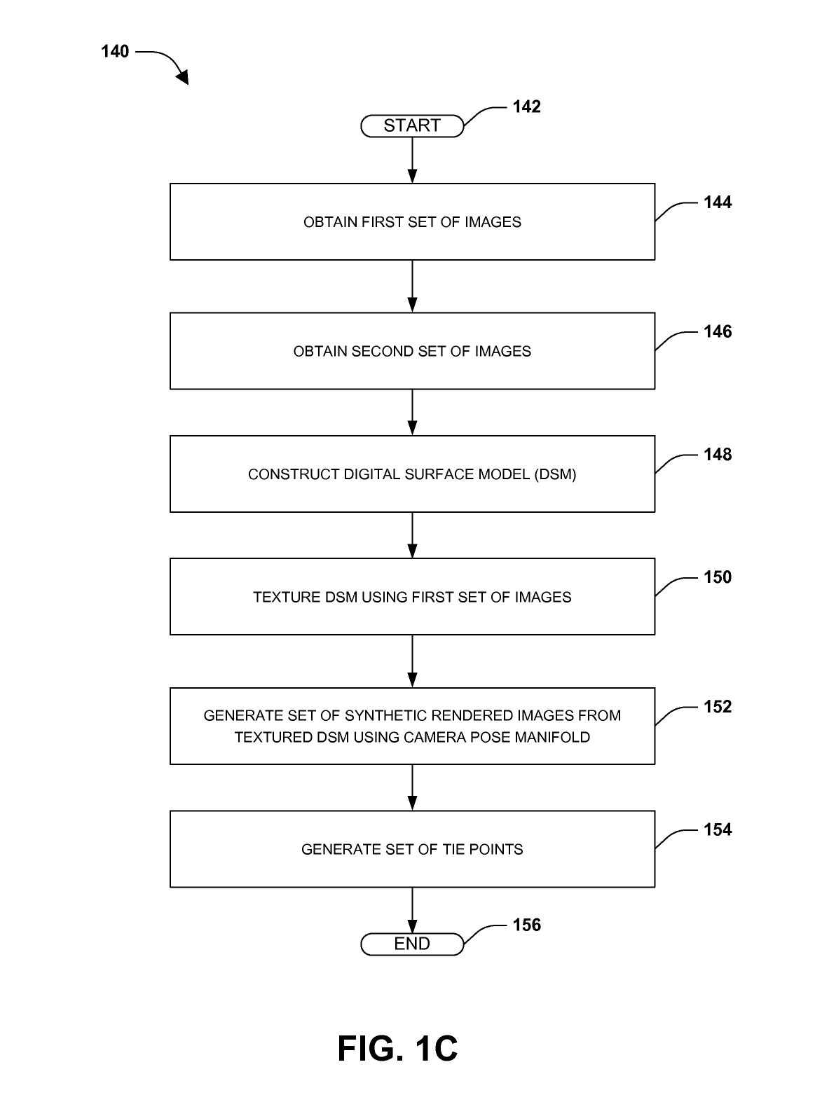

An embodiment of facilitating recalibration of a multi-sensor camera is illustrated by an exemplary method 100 of FIG. 1A. At 102, the method starts. A multi-sensor camera may comprise one or more sensors. In an example, the multi-sensor camera may comprise a nadir sensor configured to capture images along a substantially plumb line or perpendicular view direction with respect to a surface of scene (e.g., a top-down view of a city from an aircraft to which the multi-sensor camera may be mounted). In another example, the multi-sensor camera may comprise one or more oblique sensors configured to capture images from angles that are tilted from a nadir viewpoint (e.g., a 45 degree view angle from the perpendicular view direction of the city). At 104, a first set of images captured from a first sensor of a multi-sensor camera may be obtained. At 106, a second set of images captured by a second sensor of the multi-sensor camera may be obtained. In some embodiments, other sets of images captured by other sensors may be obtained.

At 108, a set of image matching pairs between one or more images (e.g., images within the first set of images, the second set of images, and/or other images captured by the multi-sensor camera) may be identified. For example, a first image matching pair may comprise overlap (e.g., a correspondence region) between a first image and a second image (e.g., an overlap between two images, such as a portion of a building depicted by both images). In an example, an image matching pair may be identified based upon overlap between a first oblique image captured by an oblique sensor and a second oblique image captured by the oblique sensor. In another example, an image matching pair may be identified based upon overlap between an oblique image captured by an oblique sensor and a nadir image captured by a nadir sensor (e.g., the nadir image may depict a rooftop of a building, and the oblique image may depict a frontal view of the building and a portion of the rooftop). In another example, an image matching pair may be identified based upon overlap between a first oblique image captured by a first oblique sensor, a second oblique image captured by a second oblique sensor, and/or a nadir image captured by a nadir sensor. In some embodiments, a correspondence region may be identified using tie points from a nadir aerial triangulation. The nadir aerial triangulation may correspond to aerial triangulation of nadir imagery (e.g., refined image poses and/or 3D points from a bundle adjustment technique) and/or global position systems (GPS)/inertial measurement units (IMU) information. In an example, geometrical operations using ray intersections between line of sight and ground surface information may be performed to determine correspondence regions where overlap occurs between multiple images.

At 110, pair-wise image matching may be performed upon the set of image matching pairs to generate a set of tie points corresponding to eccentricity information that may be updated (or not) and used to facilitate recalibration of the multi-sensor camera. In an example, pair-wise image matching may identify a correspondence (e.g., link together) multiple images having similar features. For example, a first image pair may comprise a first image depicting a rooftop of a house and a second image depicting the rooftop and a frontal view of the house. A second image pair may comprise the second image depicting the rooftop and the frontal view of the house and a third image depicting the rooftop and a side view of the house. The pair-wise image matching may determine that a first tie point, corresponding to the rooftop, may be comprised within the first image, the second image, and the third image. It can be appreciated that pair-wise image matching may thus utilize a feature-based matching algorithm configured to match regions that are identified for matching (e.g., a region of interest (e.g., the rooftop) may correspond to a portion of scenery depicted by multiple images (e.g., the rooftop in the first image, the second image, and the third image)). The first tie point may be combined with other tie points to generate the set of tie points.

In some embodiments, a densification technique may be performed to refine the set of tie points. For example, a 3D point may be estimated based upon a nadir aerial triangulation of the multi-sensor camera. The 3D point may be re-projected into an image (e.g., an oblique image captured by an oblique sensor) to obtain a corresponding coordinate of the 3D point within the image. An observation may be generated based upon the corresponding coordinate using an image matching technique. The observation may be used to update or refine the set of tie points.

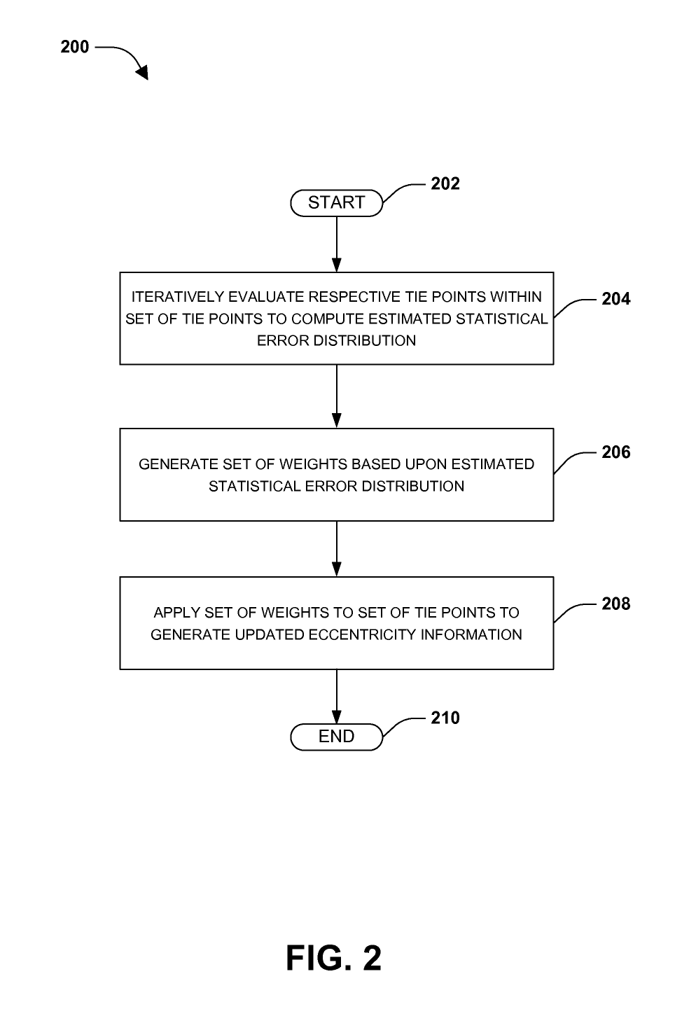

In some embodiments, bundle adjustment may be performed using the set of tie points (e.g., as refined by densification or not) to generate updated eccentricity information used to recalibrate the multi-sensor camera (e.g., bundle adjustment of FIG. 2). At 112, the method ends.

An embodiment of facilitating recalibration of a multi-sensor camera is illustrated by an exemplary method 120 of FIG. 1B. At 122, the method starts. At 124, a set of images captured by one or more sensors of a multi-sensor camera are obtained. At 126, a 3D point (e.g., a 3D tie point) may be estimated based upon a nadir aerial triangulation of the multi-sensor camera (e.g., 3D tie points from the nadir aerial triangulation may be used to identify images having similar viewing angles and/or may be re-projected into oblique images that may potentially “see” or depict the 3D tie point). For example, the 3D point may be estimated based upon a point in the scene and a camera position (e.g., in the air) over the scene. At 128, the 3D point may be re-projected into a first image within the set of images (e.g., an oblique image captured by an oblique sensor) to obtain a corresponding coordinate of the 3D point within the first image. For example, an array may be established from the 3D point into the first image to obtain an x/y coordinate.

At 130, a first observation may be generated based upon the corresponding coordinate using an image matching technique. The first observation may indicate that the 3D tie point, of a nadir view, is depicted within the first image, such as an oblique image, at the corresponding coordinate. In an example, a standard least-squares image matching technique may be utilized to obtain the first observation. The first observation may be used to facilitate recalibration of the multi-sensor camera. In some embodiments, a set of observations may be generated based upon re-projecting a set of 3D points into respective images within the set of images. The set of observations may be used to facilitate recalibration of the multi-sensor camera. In some embodiments, bundle adjustment may be performed using the set of observations to generate updated eccentricity information used to recalibrate the multi-sensor camera (e.g., bundle adjustment of FIG. 2). At 132, the method ends.

An embodiment of facilitating recalibration of a multi-sensor camera is illustrated by an exemplary method 140 of FIG. 1C. At 142, the method starts. At 144, a first set of images captured by a first sensor of a multi-sensor camera may be obtained (e.g., nadir images captured by a nadir sensor). At 146, a second set of images captured by a second sensor of a multi-sensor camera may be obtained (e.g., oblique images captured by an oblique sensor). At 148, a digital surface model (DSM) is constructed using a dense image matching technique based upon the first set of images (e.g., one or more nadir images) and/or aerial triangulation associated with the first set of images (e.g., nadir aerial triangulation). The DSM may represent a multi-dimensional surface of a scene (e.g., based upon depth information) depicted by one or more images captured by the first sensor. At 150, the DSM is textured using the first set of images to create a textured DSM. For example, texture information (e.g., pixel color values) from the first set of images may be assigned to points of the DSM (e.g., overlapping contributions may be blended; unseen portions may be in-painted; etc.).

At 152, a set of synthetic rendered images may be generated from the textured DSM using a camera pose manifold associated with one or more oblique sensors of the multi-sensor camera. For example, the textured DSM may represent a multi-dimensional surface of the scene. The camera pose manifold may represent various view perspectives of the textured DSM from which synthetic rendered images may be generated. At 154, a set of tie points may be generated based upon evaluating the set of synthetic rendered images against the second set of images (e.g., one or more oblique images) using an image matching technique. The set of tie points may be used for facilitating recalibration of the multi-sensor camera. In some embodiments, bundle adjustment may be performed using the set of tie points to generate updated eccentricity information used to recalibrate the multi-sensor camera (e.g., bundle adjustment of FIG. 2). At 156, the method ends.

An embodiment of facilitating recalibration of a multi-sensor camera is illustrated by an exemplary method 200 of FIG. 2. In some embodiments, a bundle adjustment technique may be performed to refine a nadir aerial triangulation based upon a set of tie points (e.g., or a set of observations) associated with one or more sensors within the multi-sensor camera (e.g., FIGS. 1A-1C). For example, pre-existing nadir aerial triangulation may be used to compute exterior orientations of one or more oblique sensors within the multi-sensor camera (e.g., exterior orientations of oblique sensors may be computed from exterior orientations of associated nadir images and eccentricity transformation). In some embodiments, a least squares optimization approach may be utilized, which may mitigate a sum of squared re-projection errors (e.g., mean squared error (MSE)). For example, outlier information associated with sensor positioning and/or orientation may be identified and/or remove based upon a Cauchy error function:

$${C}_{Cauchy} = log ( \frac{1}{{s}^{2} + {e}^{2}} ) ,$$

where (e) is an observed error and (s) is a positive scale factor that controls a shape of a robust cost function and determines a magnitude of attenuation for errors. In an example, estimation of the scale factor may be performed on re-projection errors of oblique image measurements. The robust cost function allows for generation of aerial triangulation of image measurements associated with nadir images and oblique images in order to recalibrate the multi-sensor camera using project data.

At 202, the method starts. At 204, respective tie points within a set of tie points (e.g., or observations within a set of observations) may be iteratively evaluated using initial calibration information of a multi-sensor camera (e.g., nadir aerial triangulation corresponding to pose information and/or 3D points associated with a nadir sensor) to compute an estimated statistical error distribution for the set of tie points. For example, re-projection errors (e.g., errors occurring when projecting 3D points onto imagery during creation of the set of tie points or observations) may result due to differences in resolution, focal length, intrinsic parameters, or other factors between image sensors within the multi-sensor camera.

At 206, a set of weights may be generated based upon the estimated statistical error distribution. For example, the set of weights may be used to remove or discount outlier information that may otherwise result in erroneous eccentricity information. At 208, the set of weights may be applied to the set of tie points (e.g., or observations) using a non-linear optimization method/procedure to generate updated eccentricity information (e.g., relative orientation and/or position information of a sensor, such as an oblique sensor, with respect to a nadir view). The multi-sensor camera may be recalibrated based upon the updated eccentricity information (e.g., in real-time, such as during a flight mission of an aircraft comprising the multi-sensor camera). At 210, the method ends.

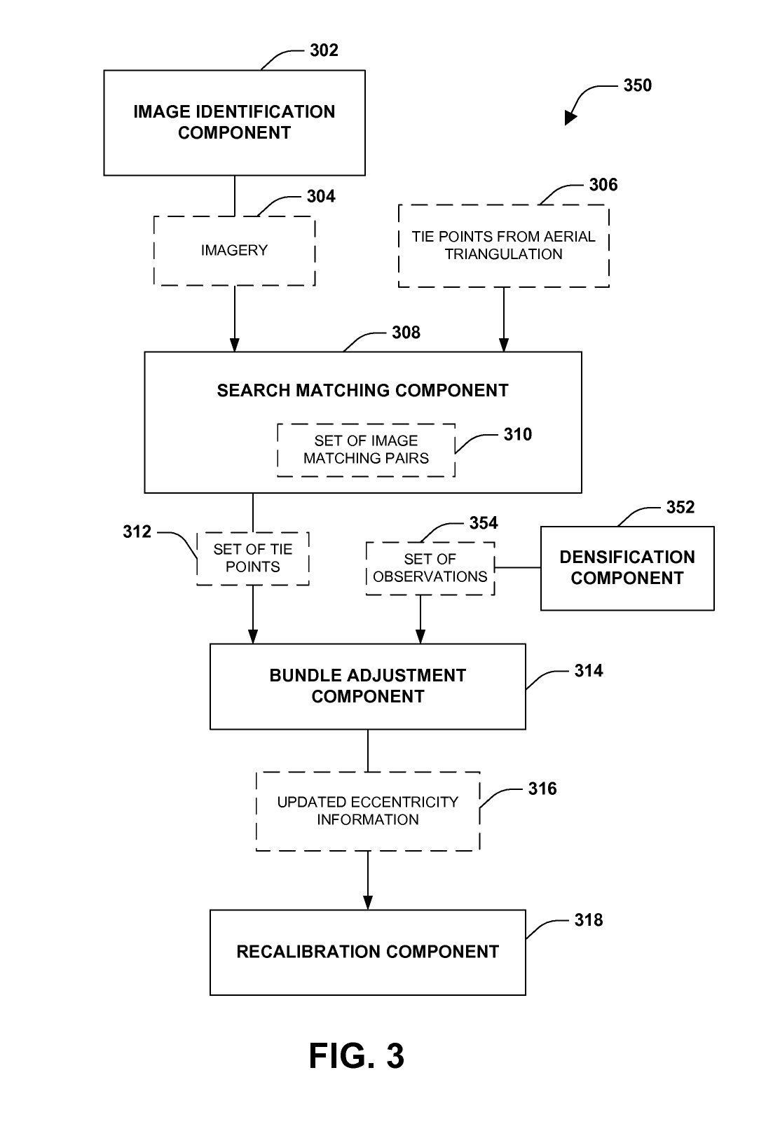

FIG. 3 illustrates an example of a system 300 for facilitating recalibration of a multi-sensor camera. The system 300 may comprise an image identification component 302 configured to detect imagery 304 associated with a multi-sensor camera. For example, the imagery 304 may comprise a set of nadir images captured by a nadir sensor within the multi-sensor camera, a first set of oblique images captured by a first oblique sensor within the multi-sensor camera, a second set of oblique images captured by a second oblique sensor within the multi-sensor camera, and/or other images. Tie points 306 from aerial triangulation (e.g., nadir tie points associated with the nadir sensor) may be identified. The tie points 306 may be used to approximate a surface of a scene depicted by the imagery (e.g., a surface model of a city as depicted by aerial images). In some embodiments, position and/or orientation information for nadir images may be identified. In some embodiments, geo-reference information within a pre-defined coordinate system may be identified.

The system 300 may comprise a search matching component 308 configured to identify a set of image matching pairs 310 between one or more images within the imagery 304. For example, a first image matching pair may identify a correspondence region (e.g., a region of overlap) between a first image and a second image (e.g., the first image and the second image may both depict a park). The search matching component 308 may be configured to perform pair-wise image matching upon the set of image matching pairs 310 to generate a set of tie points 312 (e.g., a physical 3D point and associated 2D image measurements, such as x/y coordinates of the 3D point within an oblique image). For example, the search matching component 308 may identify a tie point based upon the park being in the first image, the second image, and a third image. The tie point can be grouped with other tie points, which may include at least some of tie points 306, to generate the set of tie points 312.

The system 300 may comprise a bundle adjustment component 314. The bundle adjustment component 314 may be configured to iteratively evaluate respective tie points within the set of tie points 312 using initial calibration information of the multi-sensor camera to compute an estimated statistical error distribution for the set of tie points 312. The bundle adjustment component 314 may be configured to generate a set of weights based upon the estimated statistical error distribution. The bundle adjustment component 314 may apply the set of weights to the set of tie points 312 (e.g., to remove outliers and/or other erroneous data due to differences in intrinsic camera parameters of sensors within the multi-sensor camera) using a non-linear optimization method/procedure, for example, to generate updated eccentricity information 316. The updated eccentricity information 316 may represent relative orientation and/or position information of a sensor, such as an oblique sensor, within respect to a nadir view. In some embodiments, the system 300 comprises a densification component 352 configured to generate a set of observations 354 that may be used by the bundle adjustment component 314 to refine the set of tie points 312 for generation of the updated eccentricity information 316. The system 300 may comprise a recalibration component 318 configured to recalibrate the multi-sensor camera using the updated eccentricity information 316.

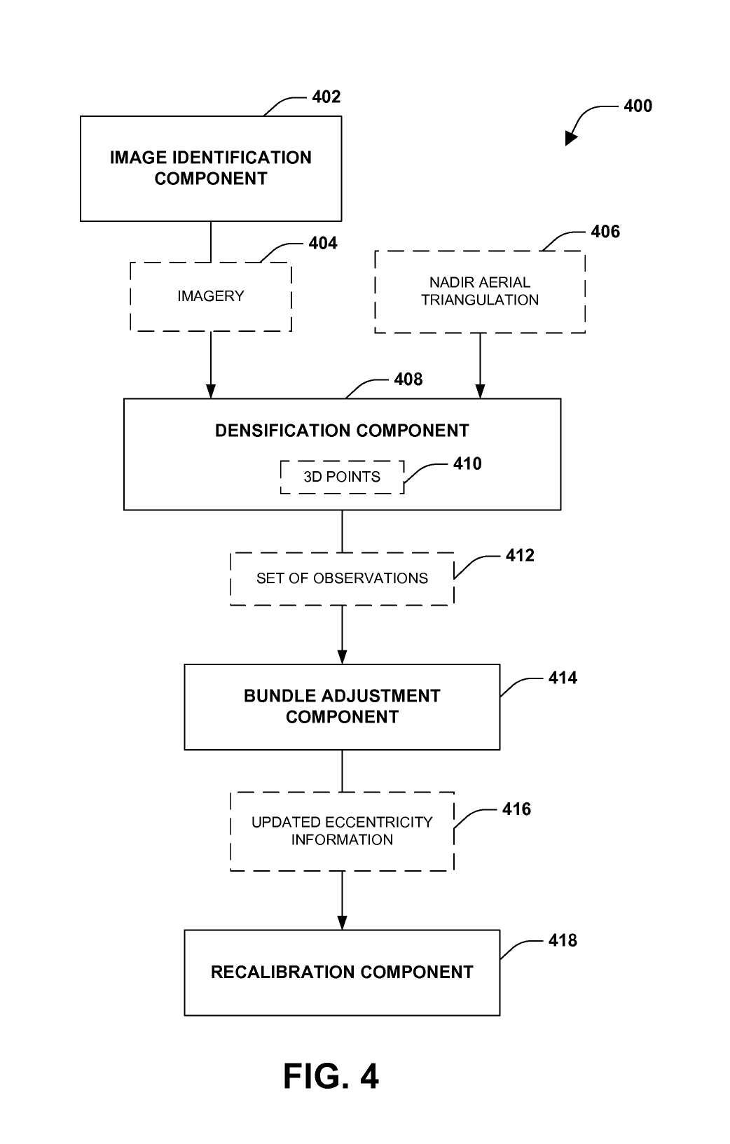

FIG. 4 illustrates an example of a system 400 for facilitating recalibration of a multi-sensor camera. The system 400 may comprise an image identification component 402 configured to detect imagery 404 associated with a multi-sensor camera. For example, the imagery 404 may comprise oblique images captured by one or more oblique sensors within the multi-sensor camera. In some embodiments, nadir aerial triangulation 406 (e.g., nadir tie points associated with the nadir sensor) may be identified.

The system 400 may comprise a densification component 408. The densification component 408 may be configured to estimate 3D points 410 based upon the nadir aerial triangulation 406. The 3D points may be re-projected into one or more images, such as oblique images within the imagery 404, to obtain corresponding coordinates of the 3D points 410 within the one or more images. The densification component 408 may be configured to generate a set of observations 412 based upon the corresponding coordinates using an image matching technique. An observation may indicate whether a 3D point is comprised within an image.

The system 400 may comprise a bundle adjustment component 414. The bundle adjustment component 414 may be configured to iteratively evaluate respective observations within the set of observations 412 using initial calibration information of the multi-sensor camera to compute an estimated statistical error distribution for the set of tie observations 412. The bundle adjustment component 414 may be configured to generate a set of weights based upon the estimated statistical error distribution. The bundle adjustment component 414 may apply the set of weights to the set of observations 412 (e.g., to remove outliers and/or other erroneous data due to differences in intrinsic camera parameters of sensors within the multi-sensor camera) using a non-linear optimization method/procedure, for example, to generate updated eccentricity information 416. The updated eccentricity information 416 may represent relative orientation and/or position information of a sensor, such as an oblique sensor, with respect to a nadir view. The system 400 may comprise a recalibration component 418 configured to recalibrate the multi-sensor camera using the updated eccentricity information 416.

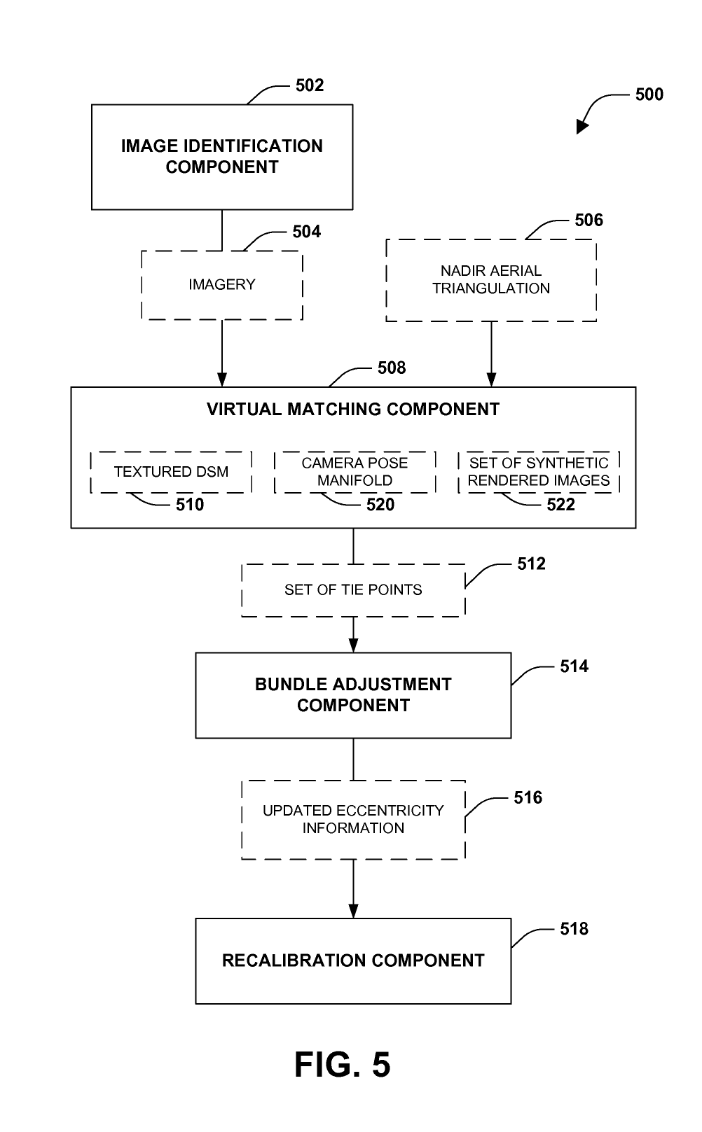

FIG. 5 illustrates an example of a system 500 for facilitating recalibration of a multi-sensor camera. The system 500 may comprise an image identification component 502 configured to detect imagery 504 associated with a multi-sensor camera. For example, the imagery 504 may comprise a set of nadir images captured by a nadir sensor within the multi-sensor camera, a first set of oblique images captured by a first oblique sensor within the multi-sensor camera, a second set of oblique images captured by a second oblique sensor within the multi-sensor camera, and/or other images. In some embodiments, nadir aerial triangulation 506 (e.g., nadir tie points associated with the nadir sensor) may be identified.

The system 500 may comprise a virtual matching component 508. The virtual matching component 508 may be configured to construct a digital surface model (DSM) of a scene depicted by the imagery 504 (e.g., a multi-dimensional surface of a city). The DSM may be constructed using a dense image matching technique based upon the imagery 504, such as a set of nadir images, and/or the nadir aerial triangulation 506. The virtual matching component 508 may be configured to texture the DSM using the imagery 504 to create a textured DSM 510 (e.g., one or more nadir images may be used to assign color values to points within the DSM). The virtual matching component 508 may identify a camera pose manifold 520 for the textured DSM (e.g., the camera pose manifold 502 may be associated with one or more oblique sensors of the multi-sensor camera). The camera pose manifold 520 may specify view perspectives of the scene that may be generated from the textured DSM. The virtual matching component 508 may generate a set of synthetic rendered images 522 from the textured DSM 510 using the camera pose manifold 520. The virtual matching component 508 may be configured to generate a set of tie points 512 based upon evaluating the set of synthetic rendered images 522 against one or more images within the imagery 504, such a set of oblique images, using an image matching technique.

The system 500 may comprise a bundle adjustment component 514. The bundle adjustment component 514 may be configured to iteratively evaluate respective tie points within the set of tie points 512 using initial calibration information of the multi-sensor camera to compute an estimated statistical error distribution for the set of tie points 512. The bundle adjustment component 514 may be configured to generate a set of weights based upon the estimated statistical error distribution. The bundle adjustment component 514 may apply the set of weights to the set of tie points 512 (e.g., to remove outliers and/or other erroneous data due to differences in intrinsic camera parameters of sensors within the multi-sensor camera) using a non-linear optimization method/procedure, for example, to generate updated eccentricity information 516. The updated eccentricity information 516 may represent relative orientation and/or position information of a sensor, such as an oblique sensor, within respect to a nadir view. The system 500 may comprise a recalibration component 518 configured to recalibrate the multi-sensor camera using the updated eccentricity information 516.

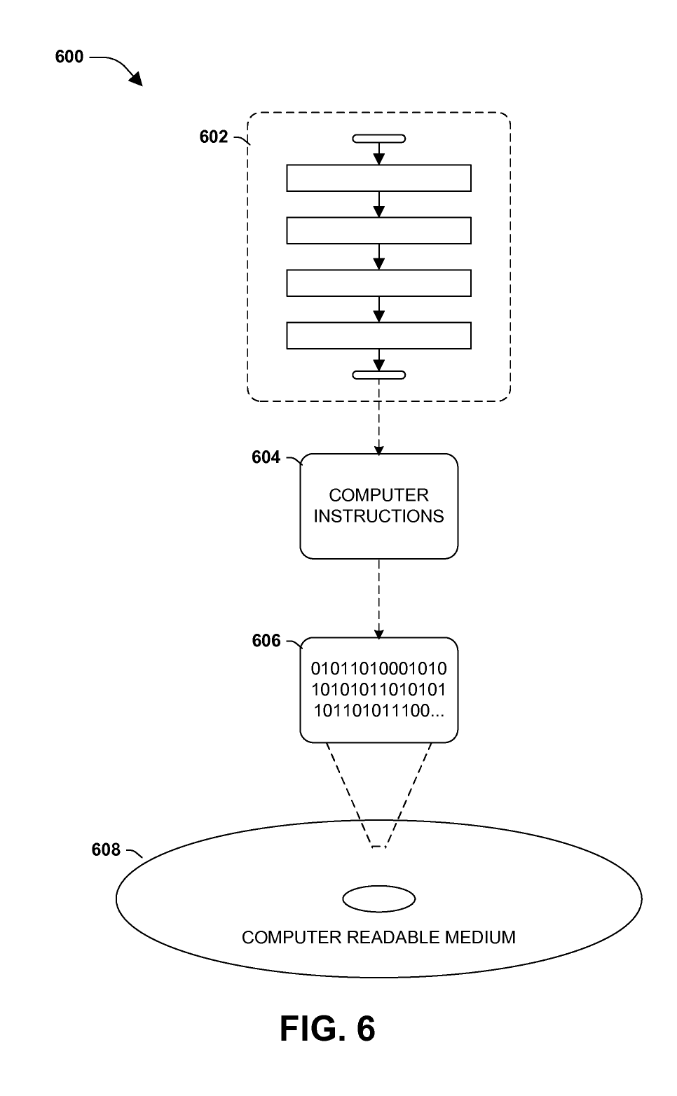

Still another embodiment involves a computer-readable medium comprising processor-executable instructions configured to implement one or more of the techniques presented herein. An example embodiment of a computer-readable medium or a computer-readable device that is devised in these ways is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1A, at least some of the exemplary method 120 of FIG. 1B, at least some of the exemplary method 140 of FIG. 1C, and/or at least some of the exemplary method 200 of FIG. 2, for example. In some embodiments, the processor-executable instructions 604 are configured to implement a system, such as at least some of the exemplary system 300 of FIG. 3, at least some of the exemplary system 400 of FIG. 4, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

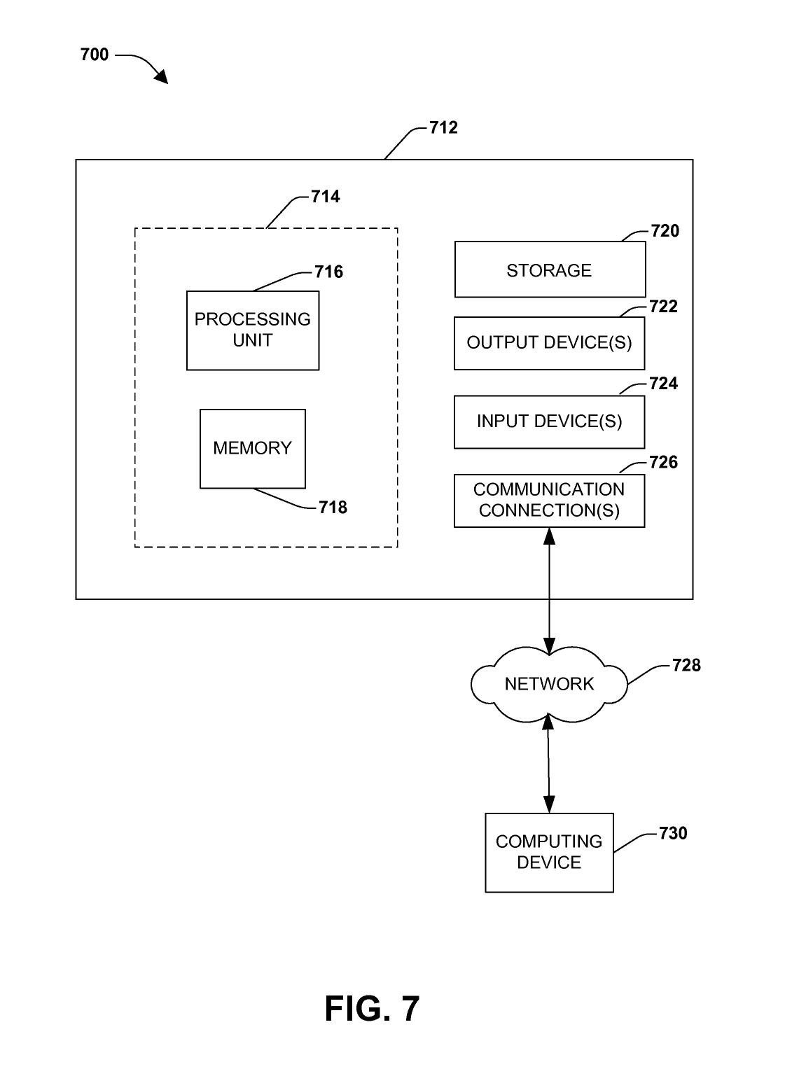

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 13104), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A system for facilitating recalibration of a multi-sensor camera, comprising:
an image identification component configured to:
obtain a first set of images captured from a first sensor of a multi-sensor camera; and
obtain a second set of images captured from a second sensor of the multi-sensor camera; and
a search matching component configured to:
identify a set of image matching pairs between one or more images captured by the multi-sensor camera based upon at least one of the first set of images or the second set of images, a first image matching pair identifying a correspondence region between a first image and a second image of the first image matching pair; and
perform pair-wise image matching upon the set of image matching pairs to generate a set of tie points corresponding to eccentricity information to facilitate recalibration of the multi-sensor camera.

2. The system of claim 1, comprising:
a bundle adjustment component configured to:
iteratively evaluate respective tie points within the set of tie points using initial calibration information of the multi-sensor camera to compute an estimated statistical error distribution for the set of tie points;
generate a set of weights based upon the estimated statistical error distribution; and
apply the set of weights to the set of tie points using a non-linear optimization procedure to generate updated eccentricity information.

3. The system of claim 2, comprising:
a recalibration component configured to recalibrate the multi-sensor camera based upon the updated eccentricity information.

4. The system of claim 1, the first sensor comprising a first oblique sensor, and the search matching component configured to:
identify an image matching pair based upon identifying overlap between a first image and a second image within the first set of images using an image matching technique.

5. The system of claim 1, the first sensor comprising a first oblique sensor and the second sensor comprising a nadir sensor, and the search matching component configured to:
identify an image matching pair based upon identifying overlap between a first image within the first set of images and a second image within the second set of images.

6. The system of claim 1, the image identification component configured to obtain a third set of images captured from a third sensor of the multi-sensor camera, and the search matching component configured to:
identify an image matching pair based upon identifying overlap between a first image of the first set of images, a second image within the second set of images, and a third image within the third set of images, the first sensor comprising a first oblique sensor, the second sensor comprising a second oblique sensor, and the third sensor comprising a nadir sensor.

7. The system of claim 1, the multi-sensor camera comprising an aerial camera.

8. The system of claim 1, the first sensor comprising a first oblique sensor and the second sensor comprising a second wing sensor.

9. The system of claim 1, the first sensor comprising a first oblique sensor and the second sensor comprising a nadir sensor.

10. The system of claim 1, the search matching component configured to:
identify a first tie point based upon a first image matching pair corresponding to a second image matching pair, the first image matching pair comprising a first image and a second image, the second image matching pair comprising the second image and a third image, the first tie point comprised within the first image, the second image, and the third image.

11. The system of claim 7, comprising an image measurement filter comprising at least one of:
a nadir to nadir measurement filter;
a baseline point measurement filter corresponding to an exposure event timing threshold; or
a redundant point filter.

12. The system of claim 1, comprising:
a densification component configured to:
estimate a 3D point based upon a nadir aerial triangulation of the multi-sensor camera;
re-project the 3D point into an image within the first set of images to obtain a corresponding coordinate of the 3D point within the image, the first sensor comprising a first oblique sensor; and
generate an observation based upon the corresponding coordinate using an image matching technique.

13. The system of claim 12, the search matching component configured to:
update the set of tie points based upon the observation.

14. A method for facilitating recalibration of a multi-sensor camera, comprising:
obtaining a set of images captured by one or more sensors of a multi-sensor camera;
estimating a 3D point based upon a nadir aerial triangulation of the multi-sensor camera;
re-projecting the 3D point into a first image within the set of images to obtain a corresponding coordinate of the 3D point within the first image, the first image captured by a first oblique sensor of the multi-sensor camera; and
generating a first observation based upon the corresponding coordinate using an image matching technique, the first observation indicative of whether the 3D point is comprised within the first image, the first observation used to facilitate recalibration of the multi-sensor camera.

15. The method of claim 14, comprising:
generating a set of observations based upon re-projecting a set of 3D points into respective images within the set of images, the set of observations comprising the first observation.

16. The method of claim 15, comprising:
iteratively evaluating respective observations within the set of observations using initial calibration information of the multi-sensor camera to compute an estimated statistical error distribution for the set of observations;
generating a set of weights based upon the estimated statistical error distribution; and
applying the set of weights to the set of observations using a non-linear optimization procedure to generate updated eccentricity information for the multi-sensor camera.

17. The method of claim 16, comprising:
recalibrating the multi-sensor camera based upon the updated eccentricity information.

18. A method for facilitating recalibration of a multi-sensor camera, comprising:
obtaining a first set of images captured by a first sensor of a multi-sensor camera;
obtaining a second set of images captured by a second sensor of the multi-sensor camera;
constructing a digital surface model (DSM) using a dense image matching technique based upon the first set of images and aerial triangulation associated with the first set of images;
texturing the DSM using the first set of images to create a textured DSM;
generating a set of synthetic rendered images from the textured DSM using a camera pose manifold associated with one or more oblique sensors of the multi-sensor camera; and
generating a set of tie points based upon evaluating the set of synthetic rendered images against the second set of images using an image matching technique, the set of tie points used for facilitating recalibration of the multi-sensor camera.

19. The method of claim 18, comprising:
iteratively evaluating respective tie points within the set of tie points using initial calibration information of the multi-sensor camera to compute an estimated statistical error distribution for the set of tie points;
generating a set of weights based upon the estimated statistical error distribution; and
applying the set of weights to the set of tie points using a non-linear optimization procedure to generate updated eccentricity information.

20. The method of claim 19, comprising:
recalibrating the multi-sensor camera based upon the updated eccentricity information.
